(19) United States
(12) Patent Application Publication
(10) Pub. No.: US 2016/0060015 A1
(43) Pub. Date: Mar. 3, 2016

(54) KIT FOR THE PREPARATION OF A FOODSTUFF AND RELATED PROCESSES FOR THE PREPARATION OF A FOODSTUFF CONTAINED IN THE KIT

(71) Applicant: APC Almacenes Productos Congelados S.A., Barcelona (ES)

(72) Inventor: Ezio Comparini, Cisterna Di Latina (LT) (IT)

(73) Assignee: APC ALMACENES PRODUCTOS CONGELADOS S.A., Barcelona (ES)

(21) Appl. No.: 14/469,869

(22) Filed: Aug. 27, 2014

(51) Int. Cl. B65D 81/34; A23L 1/39; B65D 77/04; A23L 1/10; A23L 1/20; B65D 43/02; A23L 1/01; A23L 1/16

(52) U.S. Cl. CPC B65D 81/3453; A23L 1/0128; A23L 1/39; A23L 1/16; A23L 1/1033; A23L 1/20; A23L 1/1041; B65D 81/343; B65D 43/02; B65D 77/04; A23V 2002/00; B65D 2577/042

(57) ABSTRACT

The invention relates to a kit for the preparation of a foodstuff by cooking within a microwave oven and/or a gas or electric convection oven, in particular of ventilated type. The kit comprises a plastic container that can be baked in a microwave oven and/or gas or electric convection oven, in particular of ventilated type, a removable plastic lid that allows said plastic container to be opened and closed, a first sealed sterilized bag containing a dry product, that may be particularly farinaceous, and a second sealed sterilized bag containing a sauce. The sauce contains a condiment part and a humid part, in addition to the humidity of said condiment part. The ratio between the condiment part and the humid part of the sauce ranges from 10% by weight to 60% by weight regarding the condiment part and from 40% by weight to 90% by weight regarding the humid part. Further, the invention relates to processes for preparing a foodstuff contained in the kit, and processes for using the kit.

### FIELD OF THE INVENTION

This invention relates to a kit for the preparation of a foodstuff. More specifically, this invention describes a kit that comprises a plastic container and a removable plastic lid, for example of polypropylene or any microwaveable material, a sauce which may have different flavors, and a dry product, that may be particularly farinaceous. Furthermore, this invention describes processes for the preparation of the foodstuff contained in the kit.

### BACKGROUND OF THE INVENTION

In recent years, there has been a significant increase of the use of ready-made dishes to shorten the long preparation of added condiments and cooking time. In particular there is a wide range of frozen entrees available that need to be stored in freezers.

The reason is the increasing need to consume quality products, especially away from home, and users can not devote much time to the various stages for preparing and cooking the dishes they want to eat.

Products available in the market are kept in sealed bags that do not allow for easy cooking and need at least a container or cooking pot, such as a pan, depending on the required preparation.

To solve this deficiency, several farinaceous products and preparations, such as pasta or rice, have been designed and are available frozen (e.g. Pasta Cup Barilla®) and/or sterilized and/or chilled in practical containers such as sealed bags that can be closed again and can be stored in freezers at −18° C. for a period of 12 to 18 months, or chilled or frozen from 4 to −8° C. and keep refrigerated for 6 to 8 months, or sterilized that can be kept on shelves at room temperature and with a duration of up to 36 months. The process for preparation of said foodstuff generally involves the following steps:
inserting the container into a microwave oven and baking it for a recommended time;
opening the container (which maintains the ideal temperature for about 20 minutes), stirring and serving.

However, such products should be stored in freezers and, when it comes with pasta and similar pre-cooked products, the precise cooking point of pasta cannot be controlled.

The same problem with the inability to control the cooking point and conservation affects pre-cooked dishes to heat or cook, which in turn should usually be stored in the refrigerator from 0 to 4 ° C., and therefore have a limited shelf life.

In light of the above, the need to find means for overcoming the disadvantages of the known products available on the market is obvious.

### OBJECTS OF THE INVENTION

Therefore, an object of this invention is to provide a kit for the preparation of a foodstuff by cooking within a microwave oven and/or a gas or electric convection oven, in particular of ventilated type. The kit comprises a plastic container and a removable plastic lid allowing said plastic container to be opened and closed by a user, the plastic container and removable plastic lid can be made of polypropylene or any other microwaveable material, and a first sealed sterilized bag a dry product, that may be particularly farinaceous, and a second sealed sterilized bag containing a sauce (a mixture of condiment and/or dressing, which may have different flavors). The first and second bags are sealed and sterilized in a manufacturing clean area and are opened by the user prior to prepare and cook the foodstuff The kit is characterized in that the sauce contains a condiment part and a humid part, in addition to the humidity of the condiment; and the ratio between the condiment part and the humid part of said sauce ranges from 10% by weight to 60% by weight regarding the condiment part and from 40% by weight to 90% by weight regarding the humid part, preferably from 20% by weight to 30% by weight regarding the condiment part and from 70% by weight to 80% by weight regarding the humid part.

Other objects and all their solutions will be described in the following with help of the appended illustrative non-limitative drawings, which are described herein below.

### BRIEF DESCRIPTION OF THE DRAWINGS

FIG. 1A shows a first sealed sterilized bag containing a dry product, which may be particularly farinaceous;

FIG. 1B shows a second sealed sterilized bag containing a sauce, which may have different flavors;

FIGS. 2A to 2H show a first embodiment of a process for the preparation of a foodstuff contained in the kit according to the invention; and

FIGS. 3A to 3B show a second embodiment of a process for the preparation of a foodstuff contained in the kit according to the invention.

### DETAILED DESCRIPTION OF THE INVENTION

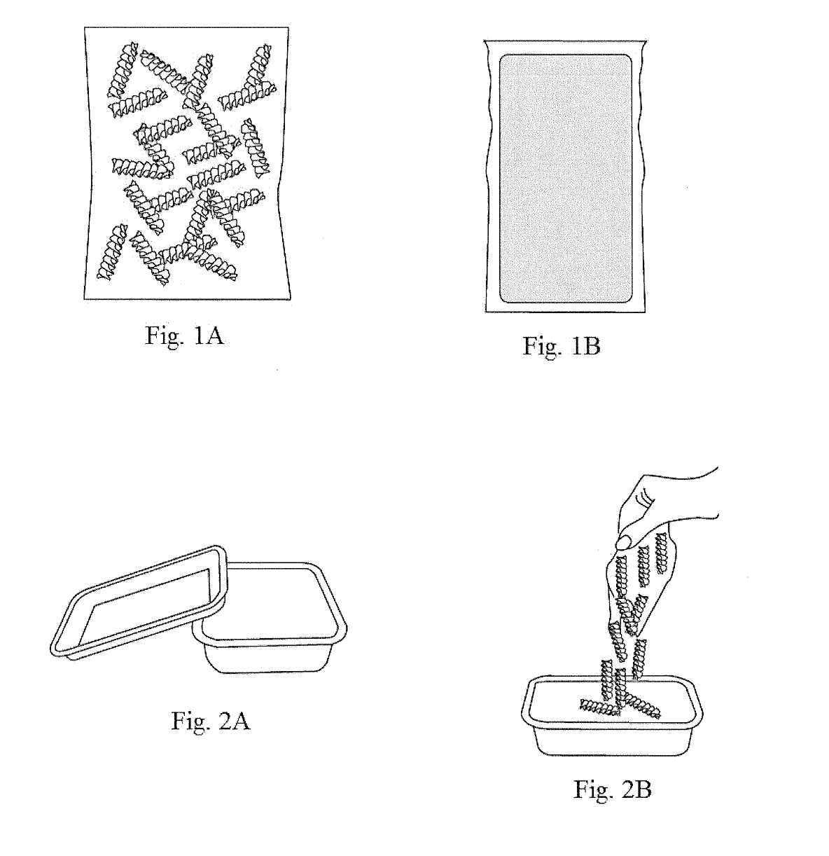

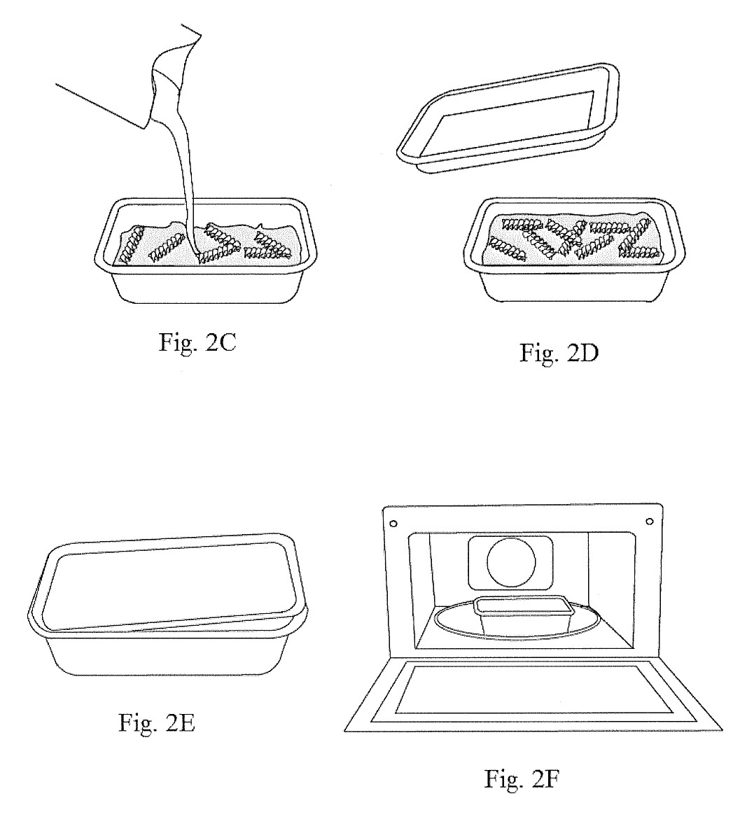

The solution to at least one of the aforementioned objects offered by the present invention consists in a kit that includes a plastic container and a removable plastic lid, a first sealed sterilized bag containing a dry product, which may be particularly farinaceous shown in FIG. 1A, and a second sealed sterilized bag containing a sauce that may have different flavors shown in FIG. 1B. The kit can be stored at room temperature, and can be prepared simply by using a microwave oven and/or a gas or electric convection oven, in particular of ventilated type, and/or a pan, a frying pan or a similar cooking device. The cooking time is in the range of 5 to 8 minutes according to the kit type.

Furthermore, the plastic container and removable plastic lid are made of, for example, polypropylene or any other microwaveable material; the plastic container is manufactured with dimensions: large 200 mm, width 158 mm, and height 46 mm, and the removable plastic lid is manufactured with dimensions: large 200 mm, width 158 mm, and height 20 mm, so that the removable plastic lid allows a user to open and close the plastic container.

Said kit can be used by removing the removable plastic lid from the plastic container, then putting the dry product, that may be particularly farinaceous, into the plastic container, then covering said dry product with the sauce poured over it in order to obtain a foodstuff that can be baked into a microwave oven and/or a gas or electric convection oven, in particular of ventilated type, and/or in a pan, a frying pan or a similar cooking device.

The cooking time in the microwave oven is of about 6 and a half minutes at 650 W (timing has been validated using a ventilated MW oven “Whirlpool” model Grand Chef JT 356). The cooking time in a 15 or 18 cm large pan is of about 6 to 7 minutes over a medium heat. In both cases the cooking time is influenced by the type of product, weight and porosity.

According to a further way of using the kit covered by the invention, the dry product and the sauce of the plastic container can be poured, for cooking, into a pan or a flying pan or a similar cooking device.

Furthermore, the kit covered by the invention, is characterized by the fact that said dry product, that may be particularly farinaceous, can be dried or precooked pasta, rice, couscous, polenta, beans, vegetables, tortellini, and the like, and/or combinations thereof.

A further kit covered by the invention is characterized by the fact that the ratio between the condiment part and the humid part of said sauce ranges from 10% by weight to 60% by weight regarding the condiment part and from 40% by weight to 90% by weight regarding the humid part, preferably from 20% by weight to 30% by weight regarding the condiment part and from 70% by weight to 80% by weight regarding the humid part.

Preferably, the sauce comprises at least one element selected from the group consisting of: tomato sauce, salt, oil, condiments such as garlic, onion, basil, parsley, rosemary, nipitella or lembitella or lempitella, bay leaves, sage leaves, nutmeg, vegetables such as carrot, celery, peas, spices such as pepper, red pepper, cloves, mint, marjoram, mushrooms, ground beef, cheese, tomatoes, vinsanto, milk, sauce, legumes, and mixtures thereof.

The invention also includes a kit with a sauce that comprises tomato sauce, salt and oil.

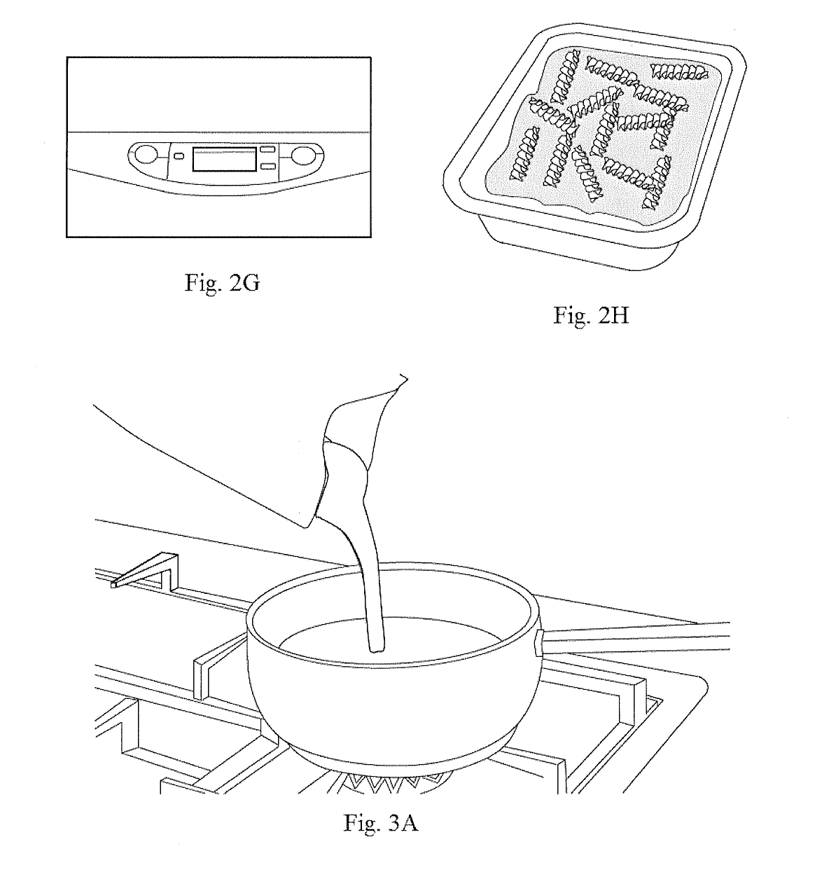

A further feature of this invention is a process for the preparation of a foodstuff contained in the kit as described above depicted in FIGS. 2A to 2H; the process comprises the following steps:
a. removing the removable plastic lid from the plastic container (FIG. 2A);
b. opening the first sealed sterilized bag containing the dry product, that may be particularly farinaceous, and putting the dry product into the plastic container (FIG. 2B);
c. opening the second sealed sterilized bag containing the sauce, the sauce containing a condiment part and a humid part, and covering the dry product with the sauce (FIG. 2C);
d. at least partially closing the plastic container with the removable plastic lid (FIGS. 2D and 2E);
e. placing the plastic container into a microwave oven and/or a gas or electric convection oven, in particular of ventilated type, preferably having a rotating plate (FIG. 2F);
f. cooking the product for a period of time sufficient to allow the foodstuff to be baked (FIG. 2G); for example, the cooking time is of about 6 and a half minutes at 650 W.

The resulting cooked product is depicted in FIG. 2H.

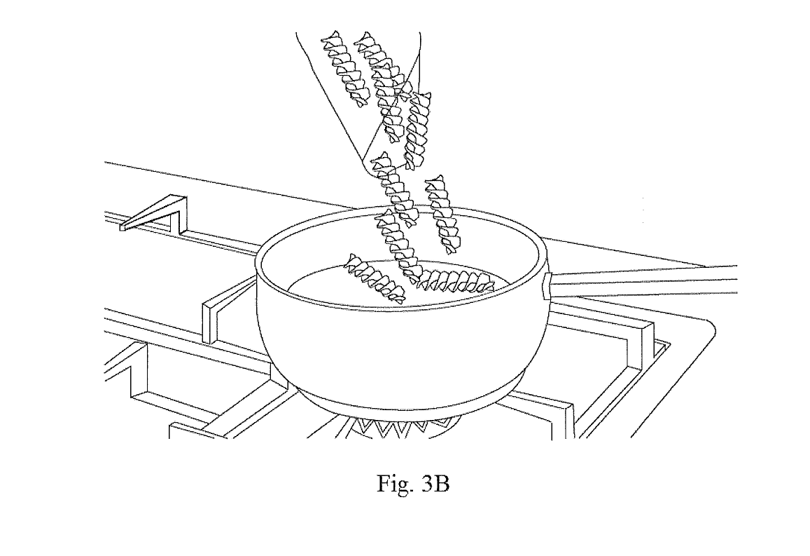

Also according to the invention, an alternative process for preparing a foodstuff contained in the kit as previously described is provided. The process comprises the steps of:
a. opening the second sealed sterilized bag containing the sauce, the sauce containing a condiment part and a humid part, and putting the sauce into a pan or frying pan or similar cooking device (FIG. 3A);
b. opening the first sealed sterilized bag containing the dry product, that may be particularly farinaceous, and putting the dry product into the pan or frying pan or similar cooking device (FIG. 3B);
c. turning on a heat source under the pan or frying pan or similar cooking device until the dry product and the sauce reach the boiling point; and
d. cooking the dry product and sauce with a cover provided on the pan or frying pan or similar cooking device.

Preferably, according to the invention, when a microwave oven with a power from 600 to 800 W is used, the cooking time ranges from 5 to 8 minutes; whereas when a gas or electric convection oven, in particular of ventilated type, is used, the cooking time ranges from 12 to 18 minutes; whereas when cooking is carried out with a pan or flying pan or similar cooking device, the cooking time ranges from 5 to 8 minutes after the dry product and sauce start boiling.

The solution offered by this invention allows for obtaining a kit for the preparation of a foodstuff that contains all the components necessary for preparation, cooking and food containment thereof, and that, once the foodstuff is consumed, the kit can be disposed of.

Food prepared with the kit of this invention allows for meeting the requirements of users who, despite the change in habits at lunchtime in favor of convenient and quick to consume meals, are unwilling to sacrifice either the taste or flavor of fresh product, safety standards and nutritional quality of food.

As this is a kit that keeps the dry product separate from the sauce containing the condiment, food preparation maintains the typical charm of homemade dishes and users' satisfaction of eating food cooked with their own hands, despite the significant reduction in the time required to prepare it. This aspect is also advantageously linked to the fact that the kit allows users to obtain the desired cooking point for pasta, for example al dente, because of the sauce, and the condiment contains an amount of water necessary to cook the dry product.

With this invention, users can also be sure that an amount of seasoning and/or condiment in the second sterilized bag containing the sauce of the kit is the right amount for seasoning the dry product, e.g. pasta, present in the first sealed sterilized bag of the kit.

A further benefit is that the kit herein described, even stored at room temperature, has a long shelf life for the edible component and therefore need not be kept in a refrigerator or freezer. Therefore, users can carry the kit with no conservation problem. This is obtained by sterilizing the bag containing the sauce and the bag containing the dry product at a temperature from 99° C. to 121° C. depending on the type of dry product and sauce contained in the bags, thus giving a shelf life of up to 36 months for the dry product, and from 12 to 24 months for the sauce, depending on the products contained in the bags.

Also, according to the present invention, a plastic container and a removable plastic lid to close and open the plastic container, for example made of polypropylene or any other microwaveable material, are provided that can be used to cook the dry product contained in the :first sealed sterilized bag.

Moreover, an amount of water of the sauce is obviously calibrated according to the type of cooking for which the dry product is intended to and it may consist of water, broth or other suitable liquid.

This invention has been described for illustrative, not limiting, purposes regarding their recommended preparation forms, but experts in the industry can alter and/or modify the kit without falling outside the scope of protection, as defined in the appended claims.

1. Kit for the preparation of a foodstuff by cooking within a microwave oven and/or a gas or electric convection oven, in particular of ventilated type, comprising:
a plastic container that can be placed into a microwave oven and/or gas or electric convection oven, in particular of ventilated type, said plastic container containing a dry product, in particular farinaceous, and a sauce; and
a removable plastic lid that allows a user to open and close said plastic container;
wherein said sauce contains a condiment part and a humid part, in addition to the humidity of said condiment; and
wherein the ratio between the condiment part and the humid part of said sauce ranges from 10% by weight to 60% by weight regarding the condiment part and from 40% by weight to 90% by weight regarding the humid part.

2. Kit according to claim 1, wherein said removable plastic lid is coupled to, or separated with respect to, said plastic container.

3. Kit according to claim 1, wherein the dry product and the sauce of said plastic container can be poured into a pan, frying pan or similar cooking device.

4. Kit according to claim 1, wherein said dry product, in particular farinaceous, is dried or precooked pasta, rice, couscous, polenta, beans, vegetables, tortellini, and/or combinations thereof.

5. Kit according to claim 1, wherein the ratio between the condiment part and humid part of the sauce preferably ranges from 20% by weight to 30% by weight regarding the condiment part and from 70% by weight to 80% by weight regarding the humid part.

6. Kit according to claim 1, wherein said sauce comprises at least one element selected from the group consisting of: tomato sauce; salt; oil; condiments such as garlic, onion, basil, parsley, rosemary, nipitella or lembitella or lempitella, bay leaves, sage leaves; nutmeg; vegetables, preferably carrot, celery, peas; spices, preferably pepper, red pepper, cloves, mint, marjoram; mushrooms; ground beef; cheese; tomatoes; vinsanto; milk; sauce; legumes; and mixtures or combinations thereof.

7. Kit according to claim 1, wherein said sauce comprises tomato sauce, salt, and oil.

8. Process for preparing a foodstuff contained in a kit having a plastic container that can be placed into a microwave oven and/or gas or electric convection oven, in particular of ventilated type, a removable plastic lid, a first sealed sterilized bag containing a dry product and a second sealed sterilized bag containing a sauce, the process comprising the following steps:
a. removing the removable plastic lid from the plastic container;
b. opening the first sealed sterilized bag containing the dry product, that may be particularly farinaceous, and putting the dry product into the plastic container;
c. opening the second sealed sterilized bag containing the sauce, the sauce containing a condiment part and a humid part, and covering the dry product with the sauce;
d. at least partially closing the plastic container with the removable plastic lid;
e. placing the plastic container into a microwave oven and/or gas or electric convection oven, in particular of ventilated type, preferably having a rotating plate;
f. cooking the product for a period of time sufficient to allow the foodstuff to be baked;
wherein the ratio between the condiment part and the humid part of said sauce ranges from 10% by weight to 60% by weight regarding the condiment part and from 40% by weight to 90% by weight regarding the humid part.

9. Process according to claim 8, wherein, when a microwave oven is used, having a power from 600 to 800 W, the cooking time ranges from 5 to 8 minutes.

10. Process according to claim 8, wherein, when a gas or electric convection oven, in particular of ventilated type, is used, the cooking time ranges from 12 to 18 minutes.

11. Process for preparing a foodstuff contained in a kit having a plastic container, a removable plastic lid, a first sealed sterilized bag containing a dry product and a second sealed sterilized bag containing a sauce, the process comprising the following steps:
a. opening the second sealed sterilized bag containing the sauce, the sauce containing a condiment part and a humid part, and putting the sauce into a pan or frying pan or similar cooking device;
b. opening the first sealed sterilized bag containing the dry product, that may be particularly farinaceous, and putting the dry product into the pan or frying pan or similar cooking device;
c. turning on a heat source under the pan or frying pan or similar cooking device until the dry product and the sauce reach the boiling point; and
d. cooking the dry product and sauce with a cover provided on the pan or frying pan or similar cooking device;
wherein the ratio between the condiment part and the humid part of said sauce ranges from 10% by weight to 60% by weight regarding the condiment part and from 40% by weight to 90% by weight regarding the humid part.

12. Process according to claim 11, wherein the cooking time ranges from 5 to 8 minutes after the dry product and sauce start boiling.
